(19) United States
(12) Patent Application Publication
(10) Pub. No.: US 2009/0119012 A1
(43) Pub. Date: May 7, 2009

(54) NAVIGATION APPARATUS

(75) Inventors: Toru Murayama, Utsunomiya-shi (JP); Hirofumi Kinoshita, Utsunomiya-shi (JP); Keisuke Kondo, Utsunomiya-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/265,258

(22) Filed: Nov. 5, 2008

(30) Foreign Application Priority Data
Nov. 7, 2007 (JP) 2007-289443

(51) Int. Cl. G01C 21/00

(52) U.S. Cl. 701/209; 701/208

(57) ABSTRACT

The navigation apparatus includes: a storage member which stores map data; a display member which displays the map data and related information to an operator; a current position detecting member which detects the current position of the operator; a destination obtaining member which obtains one or a plurality of destinations according to an input by the operator; a vicinity facility searching member which searches for facilities in the vicinity of a search range set by the operator from the map data, and adds a new destination from a search result according to the input by the operator; and a visiting order setting member which determines a visiting order for each of the destinations.

### BACKGROUND OF THE INVENTION

1. Field of the Invention

The present invention relates to a navigation apparatus.

Priority is claimed on Japanese Patent Application No. 2007-289443, filed Nov. 7, 2007, the contents of which are incorporated herein by reference.

2. Description of Related Art

Conventionally, there is known a navigation apparatus for searching stopping places, considering additionally required time or distance that a passenger may permit, in comparison with the required time or mileage from the current position to a final destination (refer to Japanese Unexamined Patent Application, First Publication No. 2002-257567, for example).

There is also known a navigation apparatus for searching facilities, for example, in the vicinity of the current position or in the vicinity of a route from the current position to a destination (refer to Japanese Unexamined Patent Application, First Publication No. 2007-139675, for example).

In the navigation apparatuses related to the above conventional technologies, when new candidates of stopping places or facilities are searched for in a state that a route from the current position to a final destination is set, the vicinity of a whole route from the current position to the final destination is used as the search range. Therefore, for example, when there is a relatively long route from the current position to a destination, a problem arises in that the search range is excessively large, and consequently, excessively large number of stopping places or facilities is listed.

The present invention has been made in view of the above situation, an object of which is to provide a navigation apparatus in which the operator can select desired search ranges, when searching for new stopping place candidates while the final destination is determined.

### SUMMARY OF THE INVENTION

One aspect of the present invention employed the followings:

(1) a navigation apparatus including: a storage member which stores map data; a display member which displays the map data and related information to an operator; a current position detecting member which detects the current position of the operator; a destination obtaining member which obtains one or a plurality of destinations according to an input by the operator; a vicinity facility searching member which searches for facilities in the vicinity of a search range set by the operator from the map data, and adds a new destination from a search result according to the input by the operator; and a visiting order setting member which determines a visiting order for each of the destinations.

According to the navigation apparatus, as compared with a case where a whole route from the current position to a final destination is used as the search range, it is possible to set the search range in detail, appropriately reflecting the intention of the operator.

The navigation apparatus may be constituted as follows:

(2) the navigation apparatus may further includes a destination selecting member which selects one of the destinations according to the input by the operator, and determines the search range to be the vicinity of the selected destination.

The navigation apparatus may be constituted as follows:

(3) the navigation apparatus may further includes an inter-destination route selecting member which selects two of the destinations according to the input by the operator, and determines the search range to be the vicinity of a route between the selected two destinations.

The navigation apparatus may be constituted as follows:

(4) the inter-destination route selecting member selects two of the destinations which are adjacent in the visiting order.

In this case, it is possible to reflect more appropriately the intention of the operator when setting the search range.

The navigation apparatus may be constituted as follows:

(5) the navigation apparatus may further includes an operation member which is rotational around an axial line and receives a rotational operation by the operator.

The navigation apparatus may be constituted as follows:

(6) the display member displays a destination selecting menu in which the one or plurality of the destinations are sorted according to the visiting orders.

The navigation apparatus may be constituted as follows:

(7) the display member displays alternately (i) a first state in which one of the destinations is selected on the destination selecting menu, and (ii) a second state in which adjacent two of the destinations are selected on the destination selecting menu, according to the input by the operator.

In this case, it is possible to readily switch the search range without complicated input operation by an operator.

Another aspect of the present invention employed the followings:

(8) A navigation method including: displaying map data and related information stored at a storage member to an operator, detecting the current position of the operator, obtaining one or a plurality of destinations according to an input by the operator, searching for facilities present in the vicinity of a search range set by the operator from the map data, adding a new destination from a search result according to the input by the operator, and determining a visiting order for each of the destinations according to the input by the operator.

The navigation method may be performed as follows:

(9) the navigation method may further includes, selecting one of the destinations according to the input by the operator, and setting the vicinity of the selected destination as the search range.

The navigation method may be performed as follows:

(10) the navigation method may further includes, selecting two of the destinations according to the input by the operator, and setting a route therebetween as the search range.

The navigation method may be performed as follows:

(11) two of the destinations adjacent in the visiting order are selected according to the input by the operator.

The navigation method may be performed as follows:

(12) the navigation method may further includes, displaying a destination selecting menu on which the destinations are listed in an order sorted by the visiting order.

The navigation method may be performed as follows:

(13) the navigation method may further includes, alternately displaying (i) a first state in which one of the destinations is selected on the destination selecting menu and (ii) a second state in which adjacent two of the destinations are selected on the destination selecting menu, according to the input by the operator.

### BRIEF DESCRIPTION OF THE DRAWINGS

FIG. 1 is a block diagram showing the navigation apparatus of one embodiment of the present invention.

FIG. 2 is a drawing showing one example of an arrangement of an input operating unit of the navigation apparatus.

FIG. 3 is a perspective view showing the input operating unit of the navigation apparatus.

FIG. 4 is a sectional view showing the input operating unit of the navigation apparatus.

FIG. 5 is a drawing showing an example of a display screen operation of a display device of the navigation apparatus.

FIG. 6 is a flow chart showing the operation of the navigation apparatus, in particular, processes of determining a search range when searching for additional stopping place candidates between the current position and a final destination, using search criteria.

FIG. 7 is a flow chart showing the operation of a navigation apparatus related to a modified example of the embodiment, showing in particular, processes to determine a search range when searching for additional stopping place candidates between the current position and a final destination, using search criteria.

FIG. 8 is a drawing showing an example of the display screen of the display device of the navigation apparatus related to the modified example of the embodiment.

### DETAILED DESCRIPTION OF THE INVENTION

Hereinafter, one embodiment of the navigation apparatus according to the present invention will be explained by referring to attached drawings.

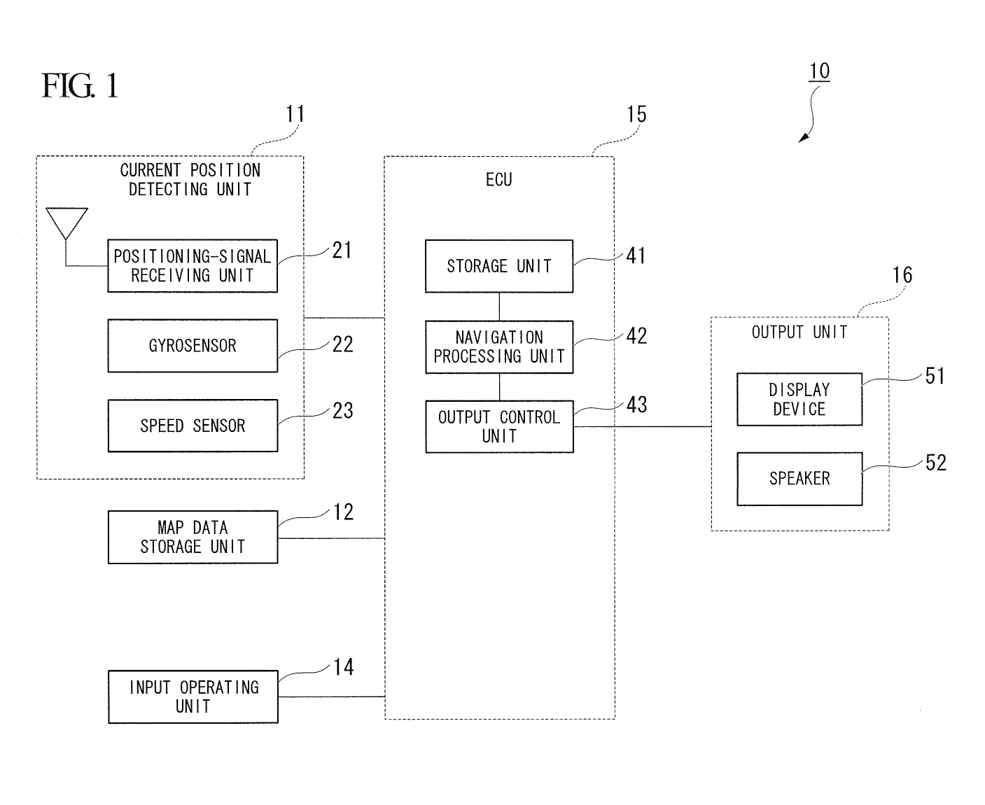

The navigation apparatus 10 of the embodiment is, for example, as shown in FIG. 1, provided with a current position detecting unit 11, a map data storage unit 12, an input operating unit 14, an electronic control unit (ECU) 15 and an output unit 16.

The current position detecting unit 11 is provided with: a positioning-signal receiving unit 21 for receiving positioning signals, for example, a GPS (Global Positioning System) signal for determining the position of a vehicle by utilizing an artificial satellite, or a DGPS (Differential Global Positioning System) signal for error correction of the GPS signal by utilizing available base station to improve the positioning accuracy; a gyrosensor 22 for detecting the orientation of the vehicle within the horizontal plane, the inclined angle with respect to the perpendicular direction (for example, the inclined angle of the front-back axis of the vehicle with respect to the perpendicular direction, and a yaw angle which is a rotational angle at the center of gravity of the vehicle about the vertical axis), and variations of the vehicle orientations (for example, yaw rate); and a speed sensor 23 for detecting the speed of the vehicle (vehicle speed). The current position detecting unit 11 calculates the current position of a vehicle by referring to the thus received positioning signals or conducting the calculation and processing of autonomous navigation based on signals detected for the vehicle speed, yaw rate or the like.

The map data storage unit 12 accommodates, for example, map data to be displayed on a display screen 51a of a display device 51 of the output unit 16 and road data including information on traffic connection conditions, and configurations of roads.

The map data includes: geographical data; polygon data corresponding to various types of facilities, city blocks, limnology or the like; character data of names of facilities, names of places or the like corresponding to each of the polygon data; data of various types of signs; and the like.

The road data includes: for example, nodes data (in other words, coordinate points representing the configuration of roads); links which are lines connecting each of the lines; and the length of each of the links; types, widths, crossing angles and configurations of roads; and the like.

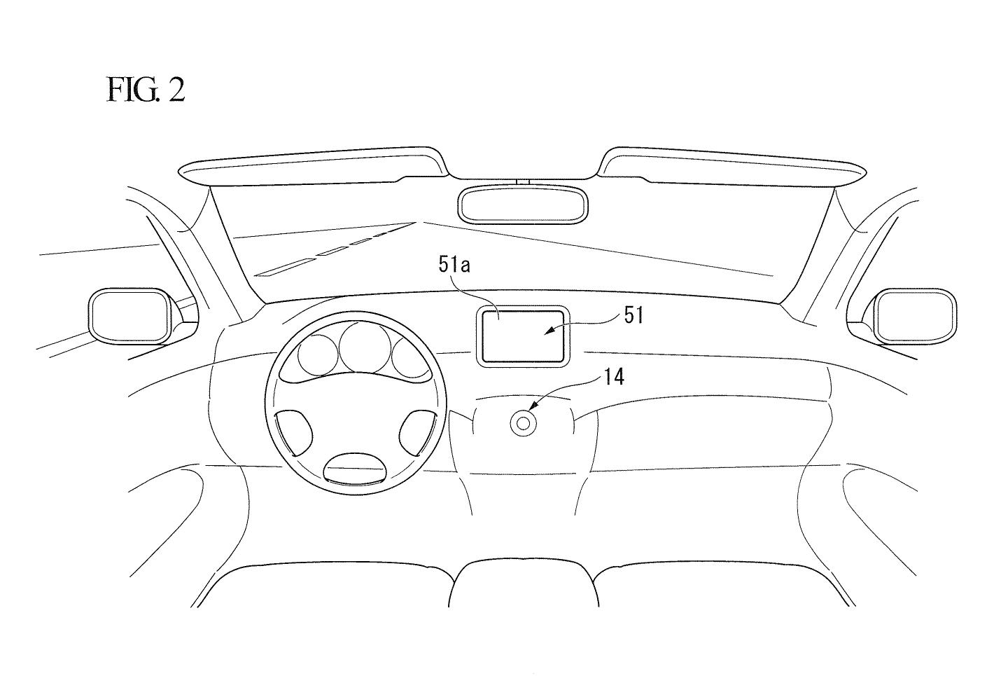

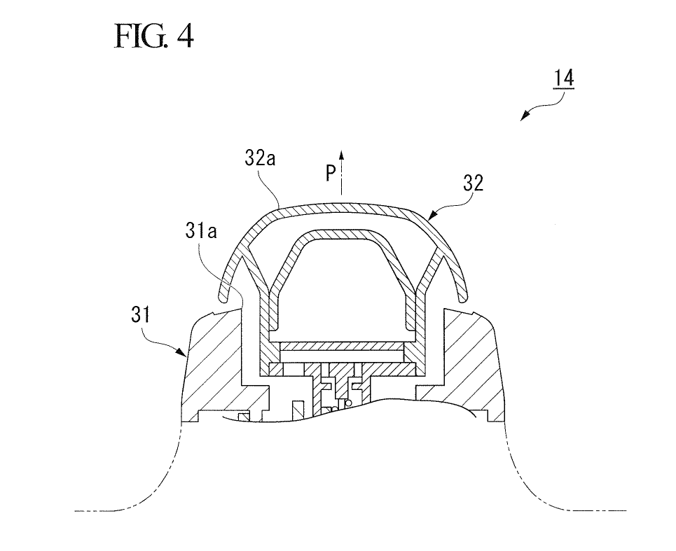

The input operating unit 14 is provided, for example, as shown in FIG. 2 to FIG. 4, with a rotational operation member 31 and a slide operation member 32 which project from an instrument panel at a position deviated downward from the position of display device 51 of the output unit 16.

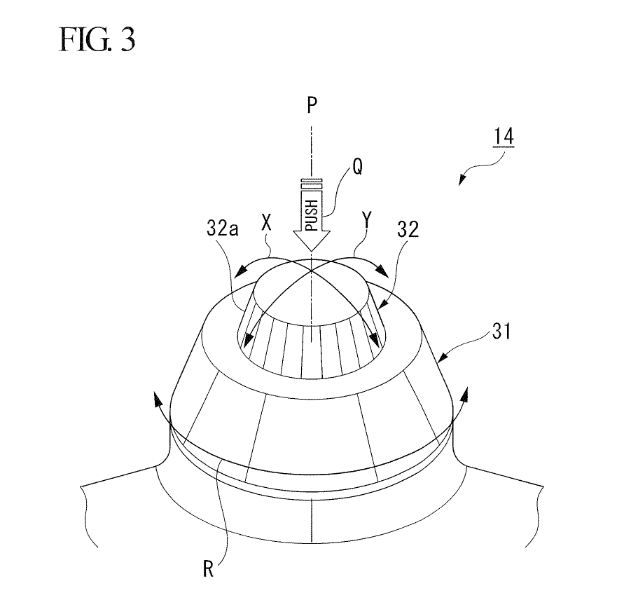

The rotational operation member 31 is formed approximately in a cylindrical shape, and is able to rotate around an axial line P (for example, along the direction indicated by the arrow R in FIG. 3).

The slide operation member 32 is approximately in a column shape with an outer diameter smaller than the inner diameter of the rotational operation member 31, and is arranged inside the rotational operation member 31 so as to be coaxial with the rotational operation member 31. A distal end portion 32a of the slide operation member 32 is arranged so as to project from an opening end 31a of the rotational operation member 31. The slide operation member 32 is movable in the direction of axial line P and any direction orthogonal to the axial line P (for example, the directions indicated by arrows X and Y in FIG. 3).

A predetermined home position is set on the slide operation member 32 in the direction of axial line P and the direction orthogonal to the axial line P. When input operations by an operator (for example, depressing operation in the direction of axial line P or sliding operation in a direction orthogonal to the axial line P) do not exist, the slide operation member 32 automatically returns to the home position by an appropriate return mechanism (not illustrated).

Further, the input operating unit 14 is provided with: a sensor (not illustrated) such as an encoder for detecting the rotational angle and rotational speed of the rotational operation member 31; and a sensor (not illustrated) for detecting displacement of the slide operation member 32 in the direction of axial line P and the direction orthogonal to the axial line P. Signals of detection values output from these sensors are input to an ECU 15.

The ECU 15 is provided, for example, with a storage unit 41, a navigation processing unit 42 and an output control unit 43.

The storage unit 41 stores, for example, the current position output from the current position detecting unit 11, and a destination set by input operation of the input operating unit 14 by an operator or the like.

The storage unit 41 also selects one from a plurality of destinations, according to, for example, an input operation using the input operating unit 14 by an operator, and determines that the selected destination is the final destination. The storage unit 41 stores destinations other than the final destination as stopping places between the current position and the final destination. The storage unit 41 also stores the visiting orders determined for each of the destinations, together with the destinations.

The navigation processing unit 42 conducts a map matching using road data obtained from the map data storage unit 12, and the current position data obtained from the current position detecting unit 11. The navigation processing unit 42 also executes processes such as route search and route guidance using the destinations determined by an operator, through input operations using the input operating unit 14. Then, the navigation processing unit 42 outputs instructions for controlling the operations of the display device 51 of the output unit 16 and those of the speaker 52.

The output control unit 43 controls the display device 51 of the output unit 16 as well as the speaker 52, for example, according to control instructions output from the navigation processing unit 42 or input operations using the input operating unit 14 by an operator.

The navigation apparatus 10 of the present embodiment is constituted as described above. Next, the operation of the navigation apparatus 10 will be explained. In particular, the processes for determining the search range will be described, which is performed in a search operation for additional stopping place candidates between the current position and the final destination, using search criteria.

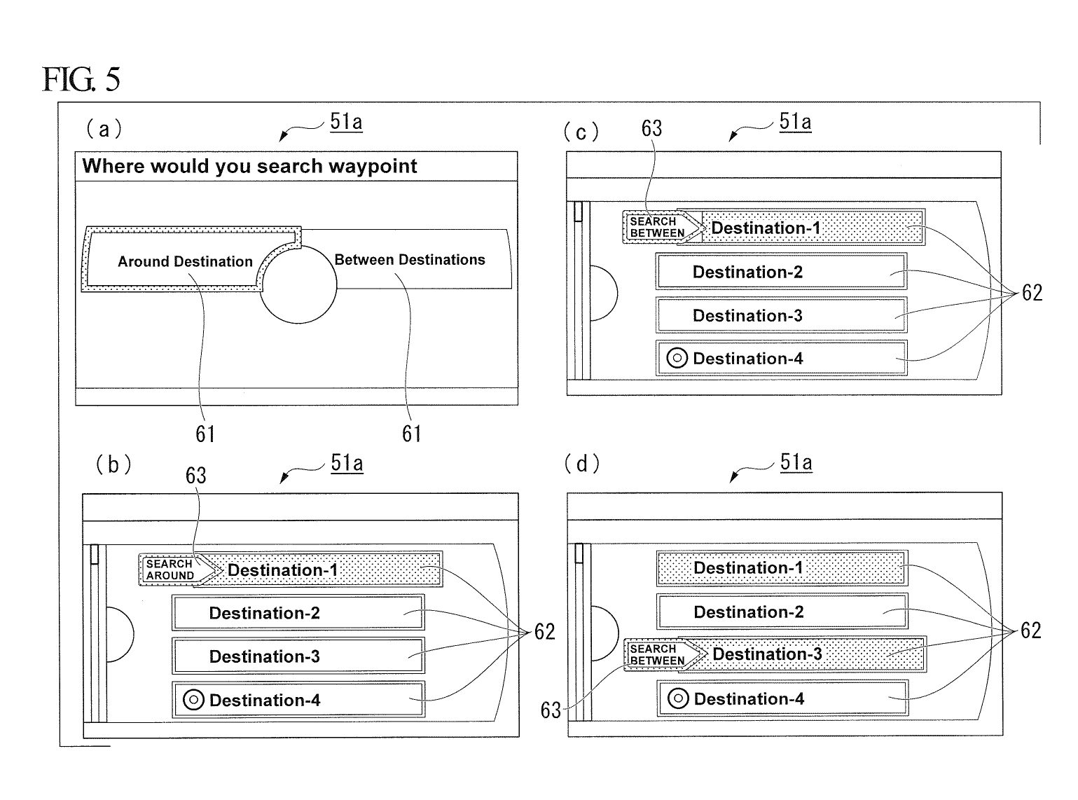

When the current position and destinations (at least a final destination) are determined, the navigation processing unit 42 accepts instructions for executing a search operation for facilities as additional destination (stopping place) candidates. An operator can input such an instruction through an input operation using the input operating unit 14, or the like. Then, for example, as shown in (A) of FIG. 5, following menus are displayed on the display screen 51a of the display device 51 of the output unit 16: (i) a command menu 61 (“Around Destination”) for instructing an execution of a point-vicinity search in which a vicinity of a position of any one of the plurality of destinations is used as a search range, and (ii) a command menu 61 (“Between Destination”) for instructing the execution of a between-points search in which the vicinity of the whole route between any two of the plurality of destinations is used as a search range.

The command menu 61 (“Around Destination”) for instructing the execution of a point-vicinity search is selected, for example, through an input operation using the input operating unit 14 by an operator. In this instance, the navigation processing unit 42 is used to display a list of individual names 62 of all destinations (for example, “Destination-1”, “Destination-2” and the like) on the display screen 51a according to visiting orders, for example, as shown in (B) of FIG. 5. Further, the name 62 of any one destination selected according to input operation of the input operating unit 14 by an operator is highlighted, together with a predetermined selection marker image 63 (“SEARCH AROUND”).

It is noted that the selection marker image 63 (“SEARCH AROUND”) has a shape capable of marking only one name 62 of all destinations displayed, for example, on the display screen 51a. Then, the selection marker image 63 (“SEARCH AROUND”) moves so as to sequentially mark each of names 62 of all destinations displayed on the display screen 51a in an visiting order (forward or backward in the visiting order), for example, according to the operation in which an operator operates the input operating unit 14 by rotating the rotational operation member 31 around the axial line P. For example, as shown in (B) of FIG. 5, only the name 62 of one destination (for example, “Destination-1”) marked by the selection marker image 63 (“SEARCH AROUND”) is highlighted.

The command menu 61 (“Between Destination”) for instructing the execution of a between-points search, for example, is selected by an input operation using the input operating unit 14 by an operator. In this instance, as shown in (C) and (D) of FIG. 5, a list of individual names 62 of all destinations (for example, “Destination-1,” “Destination-2” and the like) is displayed according to visiting orders by the navigation processing unit 42 on the display screen 51a. Further, the names 62 of any two destinations selected according to input operation of the input operating unit 14 by an operator are highlighted, together with the predetermined selection marker image 63 (“SEARCH BETWEEN”).

It is noted that the selection marker image 63 (“SEARCH BETWEEN”) has a shape capable of marking only one name 62 of all displayed destinations on the display screen 51a. Then, on the selection marker image 63 (“SEARCH AROUND”), an operator is able to operate the input operating unit 14 to rotate the rotational operation member 31 around the axial line P. As the operator rotates the rotational operation member 31, each one of the names 62 of all destinations displayed on the display screen 51a is sequentially marked in the visiting order (forward or backward in the visiting order). In the example shown in (D) of FIG. 5, the name 62 of a destination (for example, “Destination-3”) is marked by the selection marker image 63 (“SEARCH BETWEEN”). In addition, in (D) of FIG. 5, another name 62 of destination (in this example, “Destination-1”) is also highlighted. This highlighting indicates that the operator previously selected the “Destination-1” by a confirmation operation (for example, depressing operation of the input operating unit 14 in the direction of axial line P to the slide operation member 32, or the like) at the time “Destination-1” is marked by the selection marker image 63 (“SEARCH BETWEEN”).

Hereinafter, an explanation will be made for a series of processes for determining a search range in the search operation for additional stopping place candidates between the current position and the final destination, using search criteria.

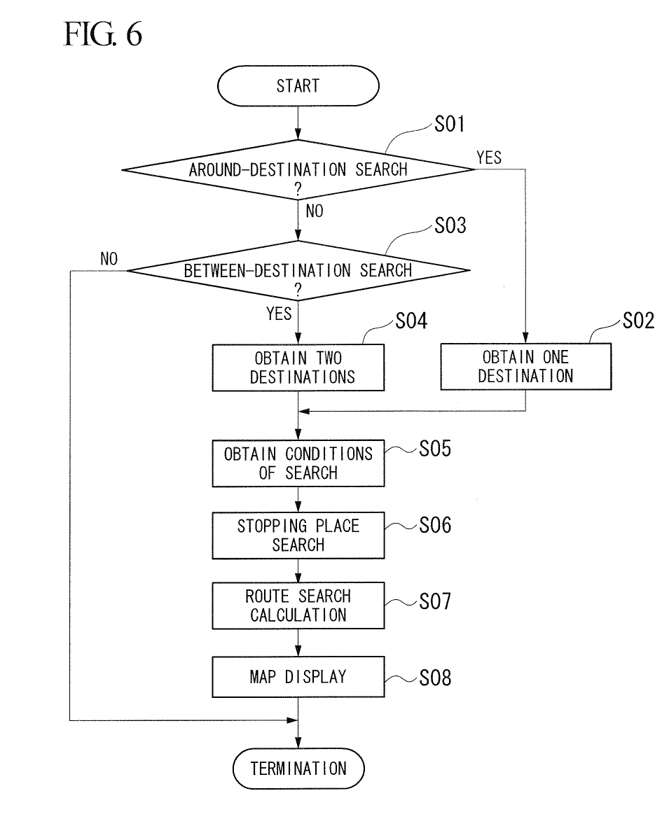

First, in Step S01 shown in FIG. 6, a determination is made as to whether the execution of a point-vicinity search is instructed or not. In the point-vicinity search, a search range is determined to be a vicinity of any one of the plurality of destinations, which is previously obtained.

When the determination result is “YES,” the process proceeds to Step S02. In Step S02, any one of the plurality of destinations is selected, according to an input operation of the input operating unit 14 by an operator. The process proceeds to Step S05, which will be described later.

On the other hand, where the determination result is “NO,” the process proceeds to Step S03.

Then, in Step S03, a determination is made as to whether the execution of a between-points search is instructed or not. In the between-points search, a search range is determined to be the vicinity of a route connecting any two of the plurality of destinations which is previously obtained.

When the determination result is “YES,” the process proceeds to Step S04. In Step S04, the operator selects any two of the plurality of destinations, through an input operation using the input operating unit 14.

On the other hands when the determination result is “NO,” the process ends.

Then, in Step S05, search criteria (for example, name or kind of candidate facilities) is determined, for example, according to input operations of the operator through the input operating unit 14.

Then, in Step S06, a search for new destination (stopping place) candidates is executed using the search range and the search criteria.

Then, in Step S07, route search calculation is executed according to a visiting order of all destinations.

Then, in Step S08, a map including the searched routes is displayed on the display screen 51a of the display device 51, and the process ends.

As described above, the navigation apparatus 10 of the present embodiment can determine a plurality of stopping places and a final destination, and then search for additional facilities as destination candidates. In this instance, (A) the vicinity of a position of any one of the plurality of previously obtained destinations or (B) the vicinity of a route between any two of the plurality of previously obtained destinations can be set as a search range. Therefore, as compared with a case where, for example, a whole route from the current position to a final destination is set as the search range, detailed arrangement of the search range is possible. It is also possible to appropriately reflect the intention of an operator in setting the search range.

In the above-described embodiment, the navigation processing unit 42 displays on the display screen 51a the command menu 61 (“Around Destination”) for instructing the execution of a point-vicinity search and the command menu 61 (“Between Destination”) for instructing the execution of a between-points search. However, the present invention is not limited thereto and, for example, the command menu 61 may be omitted.

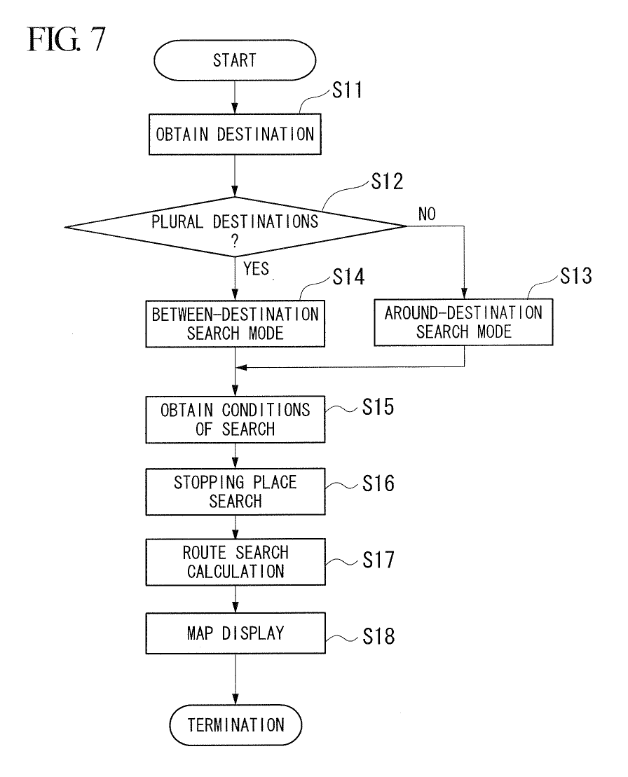

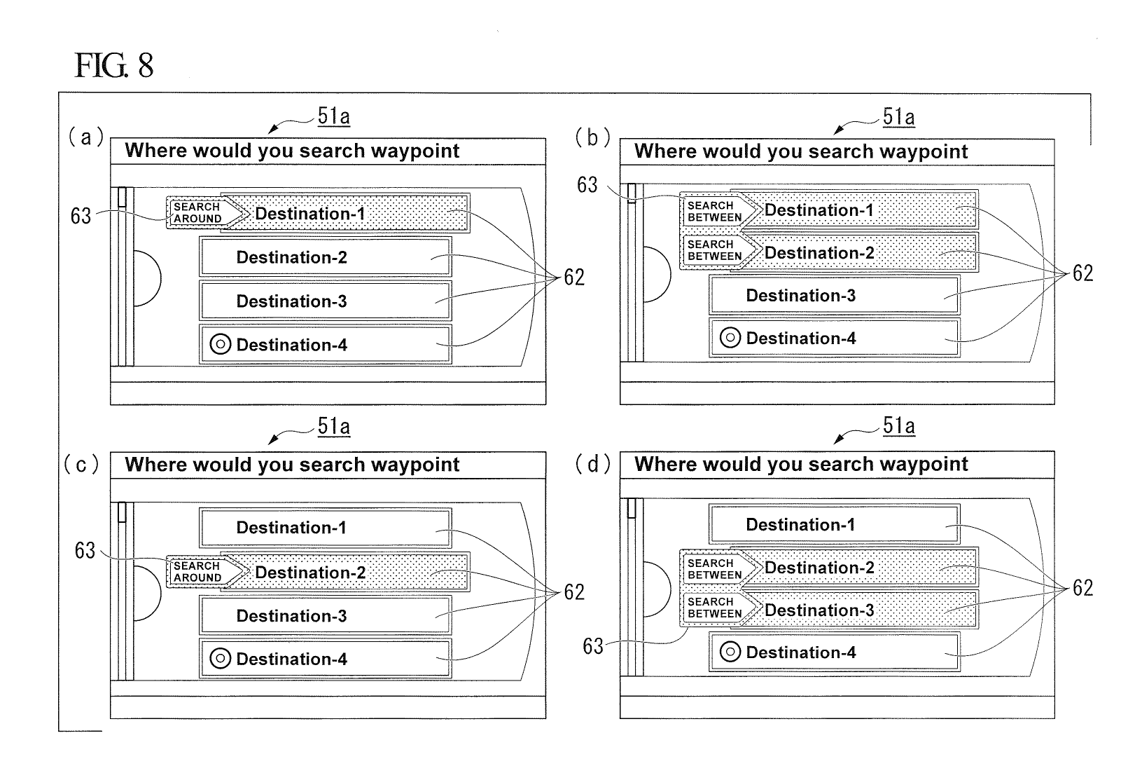

The operation of the navigation apparatus 10 related to a modified example of the above-described embodiment is explained in FIG. 7. For example, as shown in (A) to (D) of FIG. 8, the selection marker image 63 (“SEARCH AROUND”) and the selection marker image 63 (“SEARCH BETWEEN”) move sequentially following the operator's operation through the input operating unit 14, by rotating the rotational operation member 31 around the axial line P. Then, one or two names 62 are marked among all destinations displayed on the display screen 51a.

For example, in (A) of FIG. 8, only one name 62 of the appropriate destinations (in this example, “Destination-1”) is highlighted and marked by the selection marker image 63 (“SEARCH AROUND”). The selection marker image 63 (“SEARCH AROUND”) has a shape capable of marking only one name 62 among the destinations displayed on the display screen 51a. In this state, the operator can execute a confirmation operation (for example, depressing operation of the input operating unit 14 to the slide operation member 32 in the direction of axial line P). Then, a point-vicinity search is executed in which the vicinity of the location of the selected destination is used as the search range.

When the name 62 of any destination (for example, “Destination-1”) is marked by the selection marker image 63 (“SEARCH AROUND”), the operator can operate the input operating unit 14 by rotating the rotational operation member 31 around the axial line P. Then, as shown in the example in (B) of FIG. 8, the name 62 of the previously marked first destination (“Destination-1” in this example) and the name 62 of another destination (“Destination-2” in the example) adjacent to the first destination (adjacent on the display screen 51a in the visiting order in the forward or backward direction) are marked together by the selection marker image 63 (“SEARCH BETWEEN”). In this instance, the selection marker image 63 (“SEARCH BETWEEN”) has a shape capable of marking only the names 62 of any adjacent two of destinations displayed on the display screen 51a. In this state, the operator can execute a confirmation operation (for example, the operation in which the slide operation member 32 is depressed by the input operating unit 14 in the direction of axial line P), and execute a between-points search in which the vicinity of a route between these destinations is used as the search range.

As explained above, the selection marker image 63 (“SEARCH BETWEEN”) can mark two names 62 of destinations (“Destination-1” and “Destination-2”, in the example) adjacent in the visiting order, on the display screen 51a. In this state, an operator can execute a rotation operation of the input operating unit 14 to rotate the rotational operation member 31 around the axial line P. Then, as shown in (C) of FIG. 8, one of the two previously marked destinations (depending on the direction of the rotation operation; “Destination-2”, in this example) becomes marked by a selection marker image 63 (“SEARCH AROUND”).

Similarly, in the state one name 62 of the destinations (“Destination-2”, in this example) is marked by the selection marker image 63 (“SEARCH AROUND”), an operator can execute a rotation operation of the input operating unit 14 to rotate the rotational operation member 31 around the axial line P. As a result, as shown in (D) of FIG. 8, the name 62 of the previously marked destination (“Destination-2”, in this example) and the name 62 of another destination (“Destination-3”, in this example) adjacent to the above destination (adjacent in the visiting order on the display screen 51a in forward or backward direction) are marked by the selection marker image 63 (“SEARCH BETWEEN”).

Hereinafter, a series of processes performed in the modified example will be explained, which is performed searching for new stopping place candidates between the current position and a final destination according to search criteria.

First, in Step S11 shown in FIG. 7, for example, in a state that a list of individual names 62 of all destinations (for example, “Destination-1,” “Destination-2” and the like) is displayed on the display screen 51a according to visiting orders, one or more of destinations are obtained, for example, according to input operations of the input operating unit 14 by an operator.

Then, in Step S12, a determination is made as to whether or not a plurality of destinations (two destinations, in the example) is obtained in Step S11.

When the determination result is “NO,” the process proceeds to Step S13.

On the other hands when the determination result is “YES,” the process proceeds to Step S14.

Then, in Step S13, the point-vicinity search mode is selected, in which the vicinity of the position of a destination obtained in Step S11 is used as the search range. Then, the process proceeds to Step S15.

Further, in Step S14, the between-points search mode is selected in which the vicinity of a route between two destinations obtained in Step S11 is used as the search range. Then, the process proceeds to Step S15.

Then, in Step S15, search criteria (e.g., name, or kind of facilities) are obtained, for example, according to input operation of the input operating unit 14 by an operator.

Then, in Step S16, a search for new destination candidates (stopping place) is performed using the search range and the search criteria.

Then, in Step S17, route search calculation is executed according to the visiting orders of all destinations.

Then, in Step S18, a map with the searched routes is displayed on the display screen 51a of the display device 51. Then the process is terminated.

According to the navigation apparatus 10 of the modified example, the vicinity of a route between two destinations adjacent in the visiting order is used as the search range in the between-points search. For this reason, it is possible to reflect more appropriately the intention of an operator in setting the search range. Further, according to the operation by an operator of the input operating unit 14 to rotate the rotational operation member 31, either of (A) the vicinity of one position among the plurality of destinations or (B) the vicinity of a route between two of the plurality of destinations can be selected as a search range, continuously and alternately. Therefore, it is possible to easily switch the search range without any complicated input operation by the operator.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A navigation apparatus comprising:
a storage member which stores map data;
a display member which displays the map data and related information to an operator;
a current position detecting member which detects the current position of the operator;
a destination obtaining member which obtains one or a plurality of destinations according to an input by the operator;
a vicinity facility searching member which searches for facilities in the vicinity of a search range set by the operator from the map data, and adds a new destination from a search result according to the input by the operator; and
a visiting order setting member which determines a visiting order for each of the destinations.

2. The navigation apparatus according to claim 1, further comprising a destination selecting member which selects one of the destinations according to the input by the operator, and determines the search range to be the vicinity of the selected destination.

3. The navigation apparatus according to claim 1, further comprising an inter-destination route selecting member which selects two of the destinations according to the input by the operator, and determines the search range to be the vicinity of a route between the selected two destinations.

4. The navigation apparatus according to claim 3, wherein the inter-destination route selecting member selects two of the destinations which are adjacent in the visiting order.

5. The navigation apparatus according to claim 1, further comprising an operation member which is rotational around an axial line and receives a rotational operation by the operator.

6. The navigation apparatus according to claim 1, wherein the display member displays a destination selecting menu in which the one or plurality of the destinations are sorted according to the visiting orders.

7. The navigation apparatus according to claim 6, wherein the display member displays alternately (i) a first state in which one of the destinations is selected on the destination selecting menu, and (ii) a second state in which adjacent two of the destinations are selected on the destination selecting menu, according to the input by the operator.

8. A navigation method comprising:
displaying map data and related information stored at a storage member to an operator;
detecting the current position of the operator;
obtaining one or a plurality of destinations according to an input by the operator;
searching for facilities present in the vicinity of a search range set by the operator from the map data;
adding a new destination from a search result according to the input by the operator; and
determining a visiting order for each of the destinations according to the input by the operator.

9. The navigation method according to claim 8, further comprising, selecting one of the destinations according to the input by the operator, and setting the vicinity of the selected destination as the search range.

10. The navigation method according to claim 8, further comprising, selecting two of the destinations according to the input by the operator, and setting a route therebetween as the search range.

11. The navigation method according to claim 10, wherein two of the destinations adjacent in the visiting order are selected according to the input by the operator.

12. The navigation method according to claim 8, further comprising, displaying a destination selecting menu on which the destinations are listed in an order sorted by the visiting order.

13. The navigation method according to claim 12, further comprising, alternately displaying (i) a first state in which one of the destinations is selected on the destination selecting menu and (ii) a second state in which adjacent two of the destinations are selected on the destination selecting menu, according to the input by the operator.
